(19) United States
(12) Patent Application Publication
(10) Pub. No.: US 2014/0039961 A1
(43) Pub. Date: Feb. 6, 2014

(54) Activities Excepted From Incrementing In Global Minimum Staffing Although Included In Satisfying Global Minimum Staffing

(71) Applicants: Sophie Merle, Eaubonne (FR); Sonia Bourak Partouche, Paris (FR); David Pasquier, La Ville aux Clercs (FR); Pascal Fischer, Montigny le Bretonneux (FR)

(72) Inventors: Sophie Merle, Eaubonne (FR); Sonia Bourak Partouche, Paris (FR); David Pasquier, La Ville aux Clercs (FR); Pascal Fischer, Montigny le Bretonneux (FR)

(73) Assignee: ORACLE INTERNATIONAL CORPORATION, Redwood Shores, CA (US)

(21) Appl. No.: 13/564,621

(22) Filed: Aug. 1, 2012

(51) Int. Cl. G06Q 10/06

(52) U.S. Cl. 705/7.16

(57) ABSTRACT

In each time period during which a facility is open, a difference is automatically checked for being greater than zero, between a minimum number of employees needed to open the facility and a current number of employees. The current number of employees is obtained based at least partially on workloads of activities in the facility, including normal activities whose workloads are determined based on forecasts and labor standards and at least one activity (“no-increment” activity) whose workload is to not be incremented. When the difference is greater than zero in any time period, an excess number of hours of minimum staffing are obtained based at least on the difference, and then allocated among the workloads of the normal activities, to obtain new workloads while keeping the workload of each no-increment activity unchanged. Therefore, workload of an no-increment activity is used in checking but the no-increment activity's workload is not incremented.

### BACKGROUND

Application programs for execution on computers, to forecast demand for labor in an organization, are known in the prior art. For example, see U.S. Pat. No. 7,222,082 by Adhikari et al. entitled “Business Volume and Workforce Requirements Forecaster” that is incorporated by reference herein in its entirety as background information. Another example of an application program is a workforce management tool that can forecast peak demand for products and/or services of an organization, and optimize employees' schedules to match peak demand. For example, see U.S. Patent Publication 20110125549 by Merle et al. entitled “Long-Term Moving Average Weekly Forecast Tools And Techniques” that is also incorporated by reference herein in its entirety as background information. Still another such application program is described in a document entitled “RELEASE CONTENT DOCUMENT”, Release 5.0.3 MiniPack E, ORACLE WORKFORCE SCHEDULING (OWS), Prepared by OWS Product Management Team, Oracle HRMS Development, published Jul. 12, 2010, 17 pages that is incorporated by reference herein in its entirety as background information.

A computer 100 (FIG. 1A) programmed with a prior application program of the type described above may first make forecasts of demand for a store (such as a grocery store or a department store) based on trend analysis of historical data and/or other inputs on various events and/or activities in the store to generate data on, e.g. sales and number of customers during each time period (e.g. of one hour) during a day, each day during a week, each week during a month, and each month in a year etc. The demand data from forecasting or other such input data is translated by the programmed computer 100 into a profile of workloads of various activities needed to operate the store each day, each activity composed of tasks. For example, a cashier activity in the store may be composed of several tasks, such as checking items being sold, ringing the items using a bar-code scanner, and receiving payment from a customer. The number of man hours required to complete these tasks can be computed based on drivers (the number of items, the number of card payments) and labor standards (or productivity). A profile of workload for the store may identify, e.g. for each 15-minute time period in each day of a given week, number of man hours of cashier activity, number of man hours of sales activity, number of man hours of stocking activity of grocery items on store shelves, number of man hours of cleaning activity etc. Man hours identified by such a workload profile may be used to generate schedules for employees that identify start and end times and each activity performed there-between.

Labor standards or productivity that may used to translate forecasts of demand as described above are typically predetermined e.g. in a governmental regulation and/or a contract with a labor union of employees in the organization. Labor standards or productivity are typically applied to two kinds of data: (A) variable, depending on demand forecast and (B) fixed, not affected by business factors, but depending on physical aspects, such as a surface area of the store. In an example of the first kind of data, labor standards for unloading boxes from a truck may specify that receipt of 100 boxes requires a stocking activity to be performed for 2 man hours. If forecast data for a store indicates that 200 boxes are expected to be received in a given day, then this forecast data is automatically translated by a programmed computer 100 of the type described above using the predetermined labor standards into a workload of 4 man hours of stocking activity in that day. In an example of the second kind, labor standards for cleaning may specify that 500 square feet of floor space requires 1 man hour of cleaning activity. Hence, if the store has a floor space of 2000 square feet, a workload of 4 man hours of cleaning activity is needed each day (as illustrated by the value 101 in FIG. 1A) regardless of forecast data.

Workloads obtained by use of either or both kinds of data described in the above paragraph may be specified, e.g. in user input to the above-described application program, as one of two kinds of activities as follows. A first kind of activities (“mobile workload activities” or simply “mobile activities”) are to be performed within a specified time window, by any number of employees available during any time period therein. For example, the store owner may provide user input to the programmed computer 100 to specify that cleaning activity 102 is of mobile workload type 103 and is to be performed in a window between a start time 104 of 5 pm and an end time 105 of 7 pm as illustrated by row 101 in FIG. 1A. The user input in such a row 101 may be translated by the above-described programmed computer 100, into any one of the following: (A) two employees performing cleaning activity for a total of 2 hours from 5 pm to 7 pm, (B) three employees performing cleaning activity for 1 hour from 5 pm to 6 pm and one employee performing cleaning activity from 1 hour from 6 pm to 7 pm, or (C) one employee performing cleaning activity for 1 hour from 5 pm to 6 pm and three employees performing cleaning activity for 1 hour from 6 pm to 7 pm, or (D) four employees performing cleaning activity for 1 hour from 5 pm to 6 pm or (E) four employees performing cleaning activity for 1 hour from 6 pm to 7 pm. As to which of these five different workloads is selected by programmed computer 100 depends on other factors, such as availability of employees in each time period, within the specified time window.

In addition to activities that are of kind 103 (of value mobile) as described above, a store owner may additionally specify to the programmed computer 100, a second kind of activities (“stationary workload activities” or simply “stationary activities”) whose workloads (specified as number of employees) cannot be moved from the specified time periods. For example, as illustrated in FIG. 1B, the store owner may provide to computer 100 user input to specify that 1 person must perform the cashier activity in each of the following time periods: 9 am to 10 am, 10 am to 11 am, 11 am to 12 pm, 1 pm to 2 pm, 2 pm to 3 pm, 3 pm to 4 pm, 4 pm to 5 pm, 5 pm to 6 pm, and furthermore that 2 persons must perform the cashier activity between 12 pm to 1 pm (lunch hour). Based on such user input, when performing workload computations, programmed computer 100 cannot move, for example 1 person performing cashier activity from the period of 12 pm to 1 pm (which initially has 2 persons) to another period, such as 6 pm to 7 pm (which initially has 0 persons), because cashier activity is specified to have a “stationary” workload. Note that workloads of stationary activities may be expressed in number of employees in each time period, while workloads of mobile activities may be expressed in man-hours in a specified time window.

The above-described programmed computer 100 may increase the workload of either or both kinds of activities, i.e. mobile workload activities and/or stationary workload activities, during translation of forecast data into global workloads at the store level, by adding up all workloads of activities in a time period, and adjusting the result of addition based on another input parameter called global minimum staffing which is illustrated in FIG. 1C. Specifically, a global minimum staffing input parameter 121 identifies a minimum number of employees needed, for a store (or other facility of an organization) to be kept open during each time period.

For example, in a small store with a single cash register, a store manager may believe that just one employee is sufficient, for the store to be kept open. A manager of a larger store may set a global minimum staffing input parameter 121 to a larger number, such as 3 employees. The global minimum staffing input parameter 121 may be specified by user input to the programmed computer 100, as the minimum number of employees in each time period (e.g. each one hour period or each 15-minute period) used by the application program to calculate workload. User input further identifies to programmed computer 100, which activities are to participate, in reaching the value (e.g. 3 in FIG. 1C) specified in global minimum staffing input parameter 121.

In a method described below (called the “global minimum staffing” method), programmed computer 100 uses individual workloads of activities specified as participating, to ensure that within each time period of a day, an overall number of employees in the store as a whole, i.e. at a global level, at least meets or exceeds the global minimum staffing input parameter 121, e.g. by increasing the workloads of the participating activities when the number of employees is less than the minimum number.

One prior art global minimum staffing method used by such a programmed computer 100 performs at least the following steps, illustrated in FIGS. 2A-2G. Step 1: Within each time period of a day, compute a sum of workload of stationary activities that participate in the global minimum staffing method. Step 2: Within each time period of the day, compute a difference between the global minimum staffing input parameter and the sum of the workload from Step 1. The result of Step 2 is an array, with one element in the array for each time period in the day. Step 3: Check if the value of each array element is negative or zero, which means the global minimum staffing input parameter has been satisfied, and if so the global minimum staffing method ends, without adjusting any workload. When the value of the array element is positive, it identifies hours of the global minimum staffing input parameter that are left unused by any participating activity (i.e. after removing workload of stationary activities that participate) during that time period.

In Step 4, computer 100 creates one or more new time windows, based on values of array elements that are positive, as illustrated in FIG. 2C. Specifically, in FIG. 2C, as array 122 in computer memory has the value 2 from 9 AM to 12 PM, Time Window #1 is created in the computer memory, with the value 2, starting at 9 AM and ending at 12 PM. Similarly, Time Window #2 is created in memory with value 1 starting at 12 PM and ending at 1 PM. Also, Time Window #3 is created in memory with the value 2 starting at 1 PM and ending at 7 PM. In Step 5, computer 100 counts, within each time window, the number of activities that have mobile workloads in the time window, as illustrated in FIG. 2D. Next, in Step 6, computer 100 sorts the new time windows, in an ascending order of the number of mobile workload activities that occur therein. In the illustrated example, the output after Step 6 shown in FIG. 2D is coincidentally identical to the input before Step 6 also shown in FIG. 2D.

Next, in Step 7, computer 100 places workloads of mobile activities into the respective time windows, as illustrated in memory shown in FIG. 2E followed by computing a difference between the array 122 and the workloads of mobile activities, to obtain array 123 that identifies the portion of the Global Minimum Staffing input parameter which is unused after all participating activities are used.

Step 8: If global minimum staffing input parameter is reached in each time period (i.e. if all elements of array 123 are zero or negative), no workload adjustment is performed and the method ends. If global minimum staffing input parameter remains unused in any time period, then workloads of all participating activities are increased so that the increased workloads meet or exceed the global minimum staffing input parameter. Specifically, computer 100 simply adds up the global minimum staffing input parameter values that remain unused in each time period (add up all values in the array 123 to obtain a result 124 (e.g. value 6 as shown at the top of FIG. 2F) and then increments the workloads of all activities that participate in the global minimum staffing method (regardless of whether the activity is stationary or mobile).

Spreading of the result 124 among workloads of participating activities is performed in two sub-steps as follows. Sub-step 8A: Calculate a factor to identify a percentage of the global workload to be used to increment the workload of each participating activity, to reach the global minimum staffing input parameter in each time period. Specifically, Factor=total global minimum staffing remaining in hours/total hours of activities participating in the global minimum staffing. As illustrated in FIG. 2F, the total workload of all participating activities is 24 and the value of result 124 is 6, so the factor is 6/24 or 0.25. Sub-step 8B: Adjust workload of each participating activity by the factor as follows. Specifically, for each activity participating in the global minimum staffing method, New workload=workload*(1+Factor). In the above-described example, each workload is scaled up by 1.25, as illustrated in FIG. 2G.

Hence, workloads of all participating activities are automatically scaled up by Step 8. If a workload was to not be scaled up in a prior art method of the type described above, the only way was for a store manager to not identify the activity (with that workload) as participating in global minimum staffing method. Hence, each activity in such a prior art method was either participating in the entirety of the global minimum staffing method (in all of Steps 1-8 described above) or not participating at all.

### SUMMARY

In several illustrative embodiments in accordance with the invention, one or more processors of one or more computers are programmed to check in each time period among a plurality of time periods during which a facility is open, whether a constraint is satisfied. In some embodiments, the constraint is on whether a difference is greater than zero, between a minimum number of employees (e.g. specified by user as being) needed to open the facility (also called global minimum staffing) and a current number of employees to do various activities in the facility. The current number of employees is obtained based at least partially on workloads of activities to be done in the facility, including activities (“normal” activities) whose workloads are determined in a normal manner (e.g. based on forecasts of demand for work to be done in the facility, and based on labor standards) and one or more activities (“no-increment” activities) to be used in checking the constraint but not in meeting the constraint (e.g. workload is to be kept unchanged).

In several such embodiments, user input may identify a specific activity as being of a type whose workload is to be excepted or excluded from being incremented (i.e. “no-increment” activity) as described below, although that specific activity is to be included in the above-described check, e.g. on whether the constraint of global minimum staffing is met. In one example, an activity of the type “repeated” is to be excepted from incrementing while included in checking, and its workload is based on user input identifying a duration, and a number of employees needed to perform the activity (but not on meeting a constraint used in the check).

When the above-described difference is greater than zero in any time period, an excess number of hours of minimum staffing are automatically computed in some illustrative embodiments and then allocated among the workloads of normal activities, by increasing them to obtain new workloads, while keeping the workload of each no-increment activity unchanged. On completion of the just-described allocation, a new current number of employees, based on at least the new workloads and the workload of each no-increment activity, equals or exceeds the predetermined minimum number in each time period.

Hence, although no-increment activities are included in one part (“checking part”) of the above-described method, the no-increment activities are excluded in another part (“incrementing part”) of the same method. Therefore, a global minimum staffing method in several embodiments of the invention is not applied indivisibly or monolithically to an activity, and instead the method is applied in parts, specifically a checking part (or beginning part) in which all activities that participate are included in meeting (or exceeding) the minimum number, and an incrementing part (or ending part) in which from among all participating activities only normal activities (“incrementable” activities) are included and therefore incremented, but certain activities (“no-increment” activities or repeated activities) are excluded and therefore unchanged.

### BRIEF DESCRIPTION OF THE FIGURES

FIG. 1A illustrates a graphical user interface of a prior art computer 100 programmed to receive user input on mobile activities.

FIG. 1B illustrates the graphical user interface of computer 100 of FIG. 1A further programmed to receive user input on stationary activities.

FIG. 1C illustrates the graphical user interface of computer 100 of FIGS. 1B and 1C further programmed to receive user input on global minimum staffing.

FIG. 2A illustrates a memory of the prior art computer 100 of FIGS. 1A-1C programmed to compute a sum of workloads of all stationary activities within each time period.

FIG. 2B illustrates the memory of prior art computer 100 of FIG. 2A programmed to check the difference between the sum of the stationary workloads and the global minimum staffing, with the result being the minimum staffing remaining after removing the stationary workload.

FIG. 2C illustrates memory of prior art computer 100 of FIGS. 2A and 2B programmed to create time windows for minimum staffing values shown in FIG. 2B.

FIG. 2D illustrates memory of prior art computer 100 of FIGS. 2A-2C programmed to count the number of mobile workloads in each time window created as shown in FIG. 2C, and sort the windows in ascending order.

FIG. 2E illustrates memory of prior art computer 100 of FIGS. 2A-2C programmed to assign mobile workloads to each of the time windows shown in FIG. 2C and to compute the minimum staffing remaining after removing the mobile workload (and stationary workload which is already removed as in FIG. 2C).

FIG. 2F illustrates memory of prior art computer 100 of FIGS. 2A-2E programmed to calculate a factor for use in spreading the minimum staffing remaining as shown in FIG. 2E.

FIG. 2G illustrates memory of prior art computer 100 of FIGS. 2A-2F programmed to use the factor shown in FIG. 2F to increment workloads of all participating activities.

FIG. 3 illustrates, in a flow chart, acts performed by a computer 300 in some embodiments of the invention, by checking global minimum staffing using activities in an organization including certain activities (“no-increment” activities or “increment-excepted” activities), and by allocating excess hours of minimum staffing to all activities used in the checking but not to those certain activities.

FIG. 4A illustrates a graphical user interface of computer 300 of FIG. 3 programmed to receive user input on no-increment activities, e.g. “repeated” activities that are of type stationary.

FIG. 4B illustrates the graphical user interface of computer 300 of FIG. 4A further programmed to receive user input on no-increment activities, e.g. “repeated” activities that are of type mobile.

FIGS. 5A illustrates a memory 1106 of computer 300 of FIGS. 3 and 4A programmed to compute a sum of workloads of all stationary activities within each time period, including any no-increment activities that are stationary.

FIG. 5B illustrates the memory 1106 of computer 300 of FIGS. 3, 4A and 5A programmed to check the difference between the sum of the stationary workloads and the global minimum staffing, with the result being the minimum staffing remaining after removing the stationary workload.

FIG. 5C illustrates memory 1106 of computer 300 of FIGS. 3, 4A, and 5A-5B programmed to create time windows for minimum staffing values.

FIG. 5D illustrates memory 1106 of computer 300 of FIGS. 3, 4A, and 5A-5C programmed to count the number of mobile workloads in each time window and sort the windows in ascending order.

FIG. 5E illustrates memory 1106 of computer 300 of FIGS. 3, 4A, and 5A-5D programmed to assign mobile workloads to each of the time windows and to compute the minimum staffing remaining after removing the mobile workload (and stationary workload which is already removed as in FIG. 5C).

FIG. 5F illustrates memory 1106 of computer 300 of FIGS. 3, 4A, and 5A-5E programmed to calculate a factor for use in spreading the minimum staffing remaining.

FIG. 5G illustrates memory 1106 of computer 300 of FIGS. 3, 4A, and 5A-5F programmed to use the factor shown in FIG. 5F to increment workloads of activities that are used in computing the minimum staffing remaining except for the no-increment activities.

FIGS. 6A and 6B illustrate, in block diagrams, hardware and software portions of a computer 300 that performs the method illustrated in FIG. 3.

### DETAILED DESCRIPTION

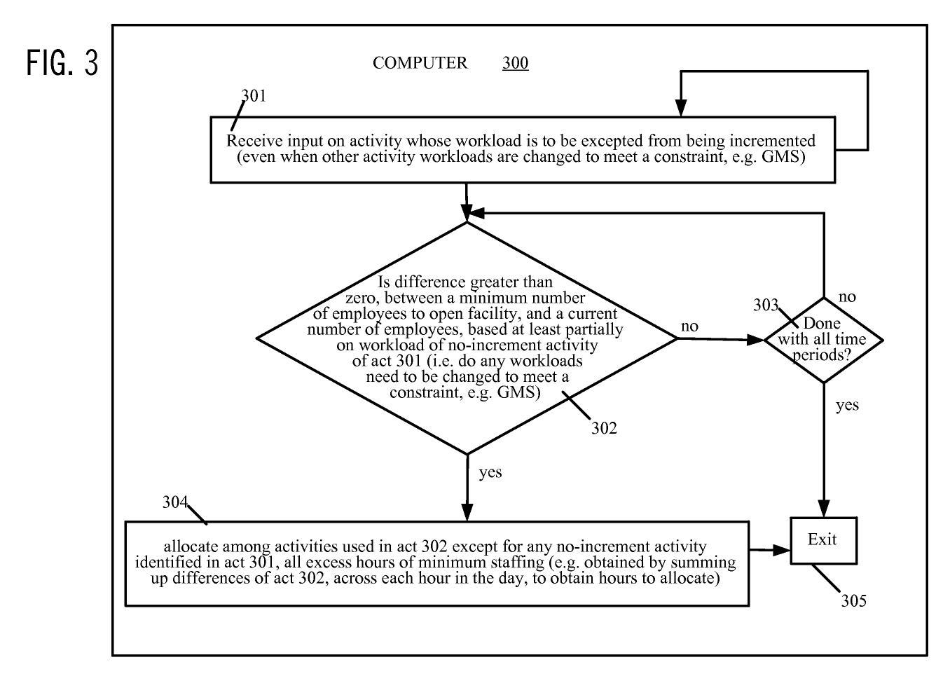

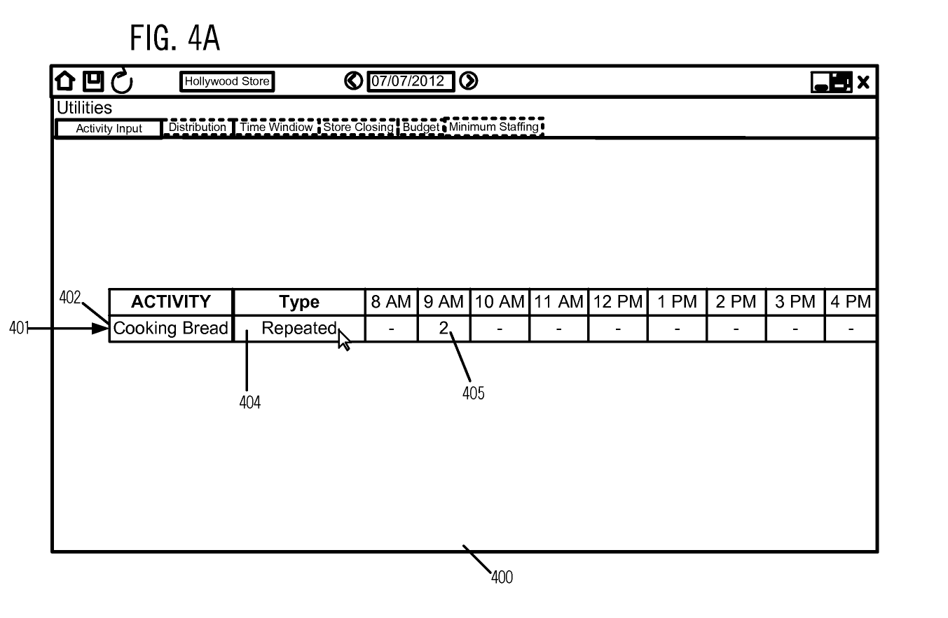

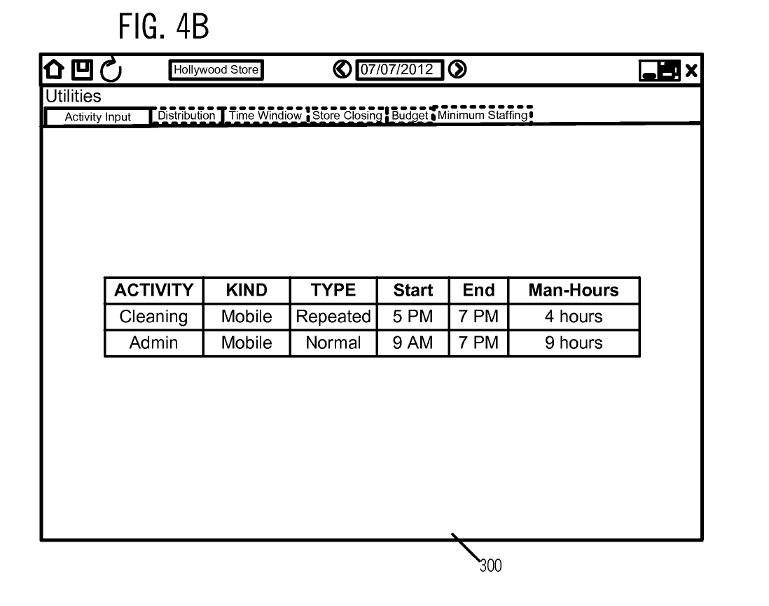

One or more computers 300 (FIG. 3) are programmed in several embodiments of the invention to receive input on an activity that is to be not changed or excepted from being changed (e.g. not incremented to satisfy a constraint), as shown by act 301. The input may be user input that is received through a graphical user interface (GUI) as illustrated in FIG. 4A. Specifically, in FIG. 4A, by selecting a value 404 for type to be “repeated” for an activity 402 of Cooking Bread, in a row 401 of a table in the computer(s) 300 (e.g. by changing a displayed value of type, using a mouse), a human user has indicated that this activity is to be a “no-increment” activity. In FIG. 4A, the Cooking Bread activity 402 is a stationary activity (stationary relative to a time of the day, such as 9 AM), and the human user may supply as user input (by typing on a keyboard) the number of employees 405 needed to perform this activity 402 (e.g. the value 2 has been received via user input as the number, as shown in FIG. 4A).

Note that the workload of such a no-increment activity is specified in some embodiments by a store manager (i.e. a human user) using input parameters which are not based on (and hence, independent of) labor standards, or productivity. Hence, in addition to a time of day and number of employees as noted above, user input on such a no-increment activity may include: (1) number of sessions (e.g. cooking), and (2) duration of each session. The just-described duration of some embodiments which is indivisible (e.g. after bread cooking starts, it must be completed). When an indivisible duration of an activity is larger than a single time period (e.g. 1 hour), workload for the activity is assigned (by computers 300) to a sequence of time periods that occur successively one after another without break (contiguously).

Although FIG. 4A illustrates successive time periods of one hour each, e.g. 8 AM, 9 AM, 10 AM, the time period may be smaller in other embodiments which may use, for example, successive time periods of 15 minutes each, e.g. 8 AM, 8:15 AM, 8:30 AM, 8:45 AM, etc. Moreover, although only a stationary activity is illustrated in FIG. 4A, as will be readily apparent in view of this detailed description, a mobile activity (e.g. cleaning activity) can be also specified by user input to be of a “repeated” type that is mobile as illustrated in FIG. 4B. In some embodiments, only those activities that cannot be interrupted are to be identified as being of the “repeated” type. A cleaning activity can be interrupted, and hence the following discussion assumes that the cleaning activity in FIG. 4B is identified by user to be of type normal.

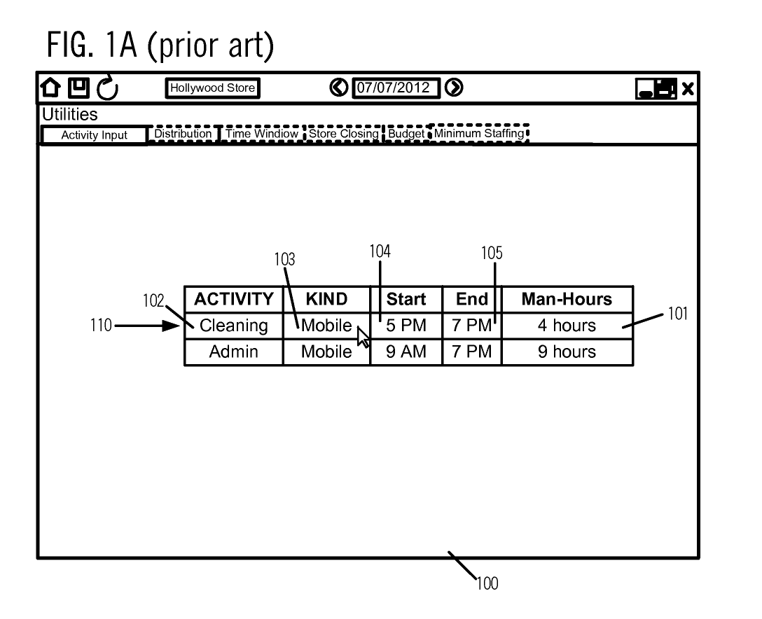

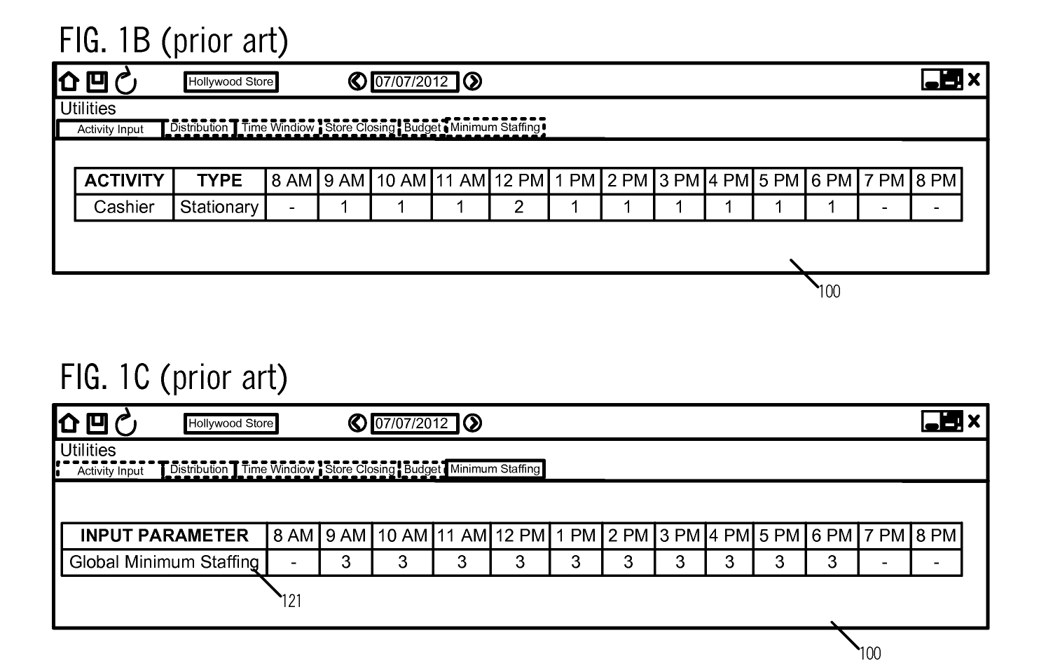

The following discussion further assumes that user input of the type illustrated in FIGS. 1A-1C has been received in computer 300 for various activities such as cleaning, cashier and admin whose workloads are dependent on labor standards and which have been identified as participating in global minimum staffing as described above. Note that such input may specify additional activities that do not participate in all parts of global minimum staffing (i.e. in its entirety).

Referring back to FIG. 3, in act 302, computer 300 checks whether a difference is greater than zero, the difference being between a minimum number of employees needed to open the facility (called “global minimum staffing” which is an input parameter) as described above and a current number of employees based at least partially on one or more activities for which input is received in act 301. When the answer in act 302 is no, meaning the difference is less or zero, then global minimum staffing is satisfied for the current interval, and thus no workloads need to be changed so computer 300 goes to act 303 to check if all time periods have been tested and if not returns to act 302. In act 303, when all time periods have been tested, then this means global minimum staffing is satisfied for all intervals and therefore computer 300 goes to act 305 to exit this method (without changing any workload).

When the answer in act 302 is yes, meaning the difference is greater than zero, then global minimum staffing is not satisfied for the current interval, and therefore workloads need to be changed and to do so computer 300 goes to act 304. In act 304, computer 300 allocates among workloads of all activities used in act 302 except for one or more no-increment activities, all excess hours of minimum staffing (e.g. obtained by summing the difference across time periods, in any given day). After the allocation of excess hours is completed, computer 300 goes to act 305 to exit this method (after changing workloads of all activities that participate in global minimum staffing except for those that are identified as no-increment activities).

Using the workload of the new type of activity (i.e. the no-increment activity) in the checking act 302 provides a more accurate (and lower) estimate of increases in workloads (of normal activities) required to meet the Global Minimum Staffing input parameter. Excluding the new type of activity (i.e. the no-increment activity) from the adjusting act 304 enables the new type of activity to be used by a customer to model work that is performed in sessions using physical resources that are limited (e.g. a single oven), and cannot be increased by adding more employees (e.g. too many cooks). The workload of the no-increment activity can be specified by input to be either stationary or mobile, depending on the activity.

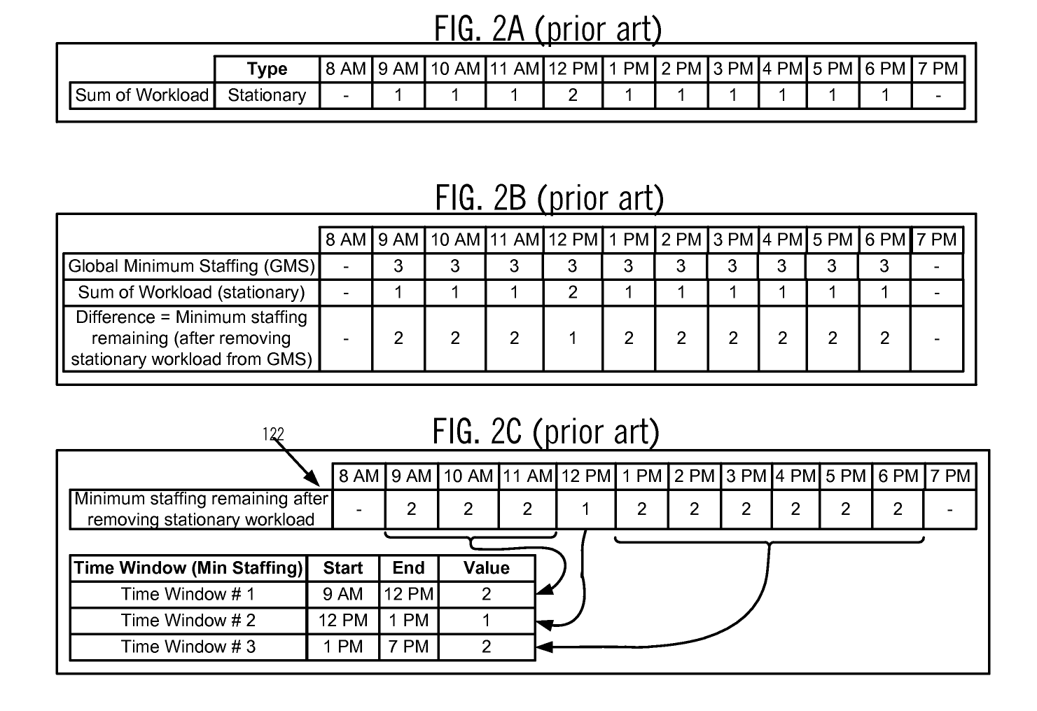

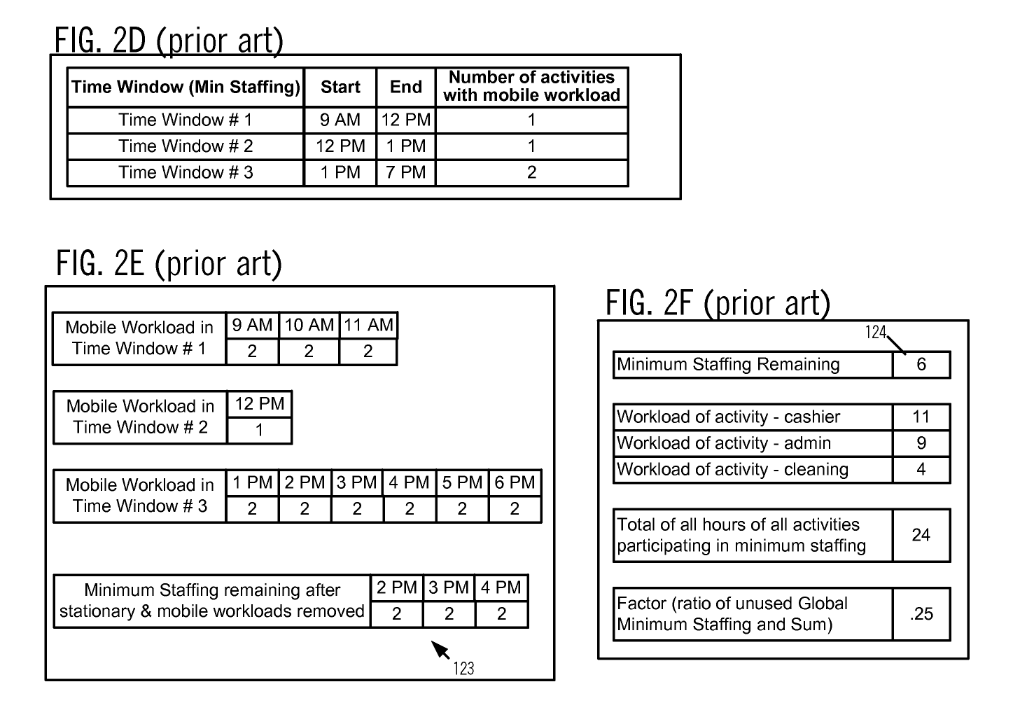

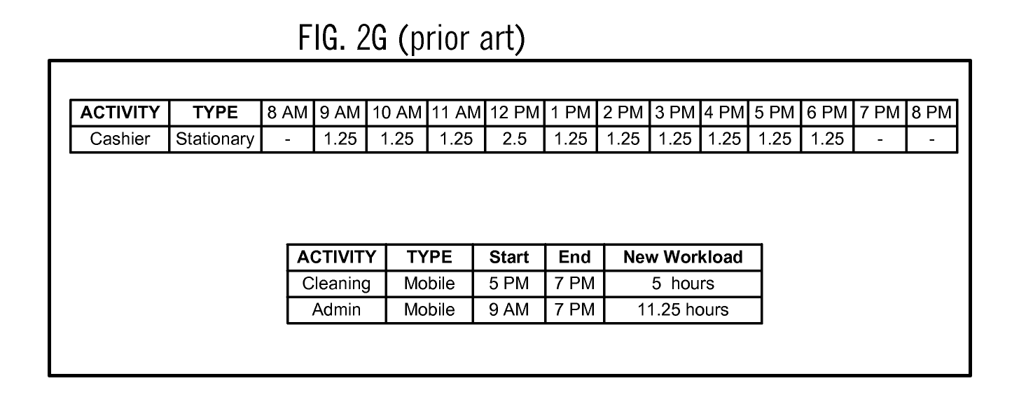

A global minimum staffing method of the prior art (see FIGS. 2A-2G, described above) is monolithic with respect to each activity, on which it is applied in its entirety.

In contrast, such a method is changed in several embodiments of the invention so that a changed method shown in FIG. 3 can be applied in two parts as discussed herein, to use the above-described no-increment type of activities in a checking part and to not use the no-increment type of activities in an incrementing part, while other activities (incrementable activities) are used in both parts. Note that although the description refers to activities with workloads that are not incremented, as will be apparent in view of this detailed description workloads of such activities are not changed at all (i.e. not incremented and not also decremented and hence unchanged).

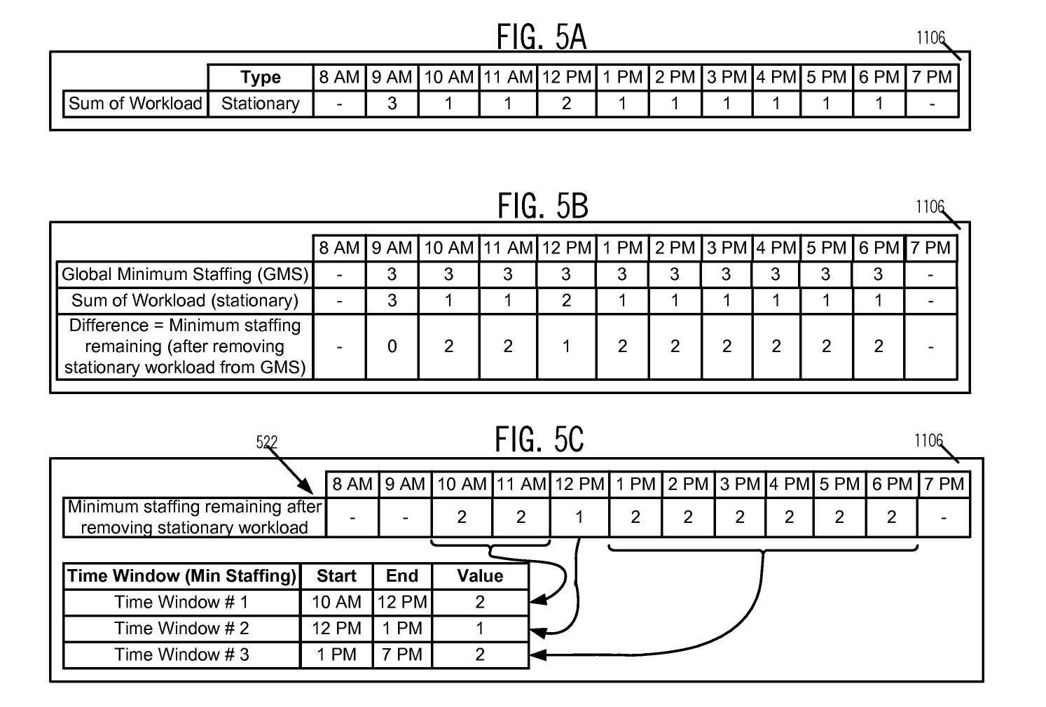

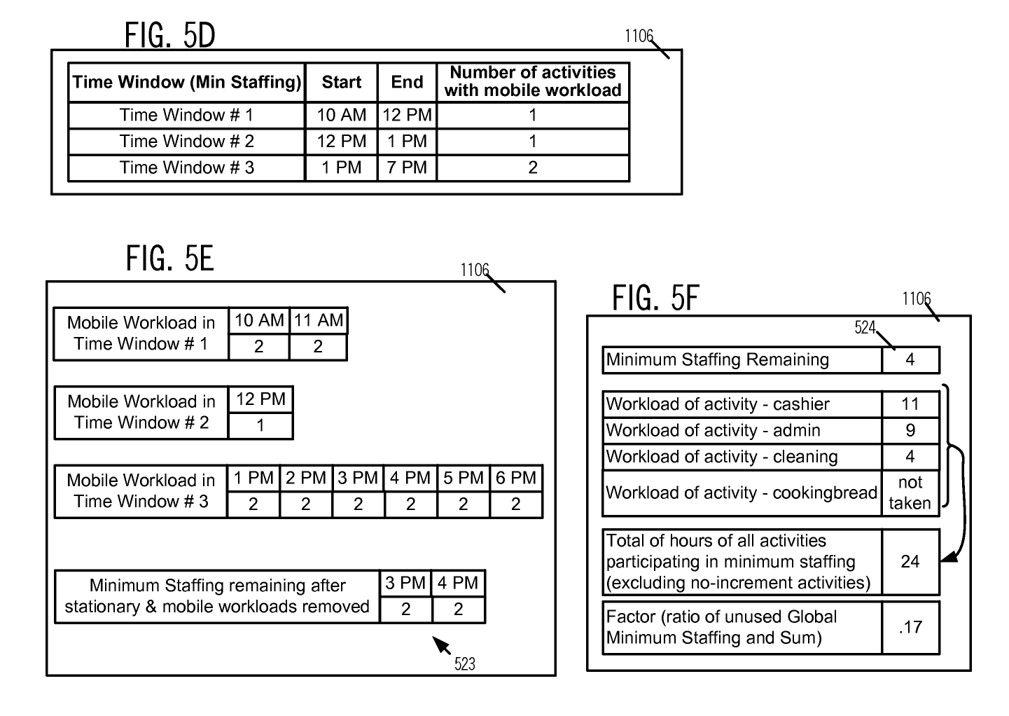

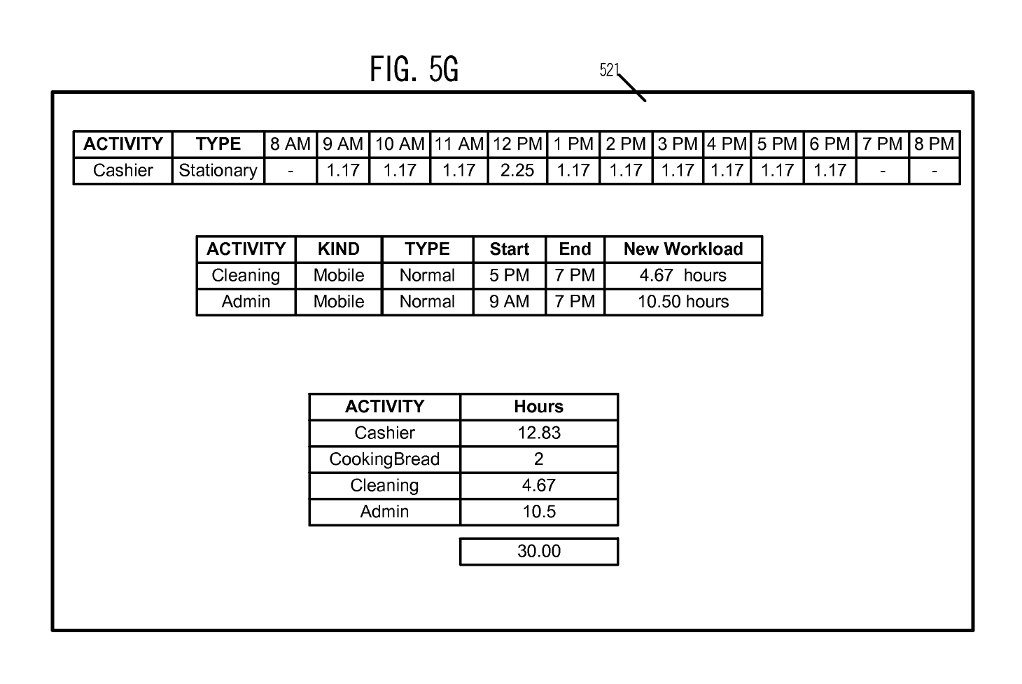

In some embodiments, programmed computer 300 of the type described above in reference to FIGS. 3 and 4A-4B is programmed to perform at least the following steps, illustrated in FIGS. 5A-5G. Step 1: Within each time period of a day, compute a sum of workload of activities that participate in the global minimum staffing method. In the example shown in FIG. 5A, the sum of the stationary workloads in the time period 9 AM to 10 AM is 3, which includes the number of employees 405 in FIG. 4A for activity 402 of repeated type 404 (which in this embodiment is predetermined to be a no-increment activity), in addition to other stationary activities such as Cashier activity. Note that the Cashier activity is shown in FIG. 1B.

Step 2: Within each time period of the day, compute a difference between the global minimum staffing input parameter and the sum of the workload of participating activities. In the example shown in FIG. 5A, the global minimum staffing input parameter is 3 in the time period 9 AM to 10 AM. Note that user input of this input parameter is shown in FIG. 1C. The difference between the value 3 of the stationary workloads sum (including no-increment activity) and the value 3 of the global minimum staffing input parameter is zero, for the time period 9 AM to 10 AM. Step 2 is repeated in this manner, for all time periods during a day. Hence, the result of Step 2 is an array, with one element in the array for each time period in the day.

Depending on the method, Steps 1 and 2 described above may be performed in multiple stages, e.g. for different types of workloads of the participating activities, such as stationary workload activities (whose workload identifies a number of employees needed in each time period within a specified time window), and mobile workload activities (whose workload identifies a number of hours of work to be done in any time period within a specified time window). For example, Steps 1 and 2 may be performed initially for stationary workload activities as illustrated in memory 1106 in FIGS. 5A and 5B. Note that no-increment activities are included in Steps 1 and 2.

Step 3: Check if the value of each array element is negative or zero, which means the global minimum staffing input parameter has been satisfied, and if so the global minimum staffing method ends, without adjusting any workload. When the value of the array element is positive, it identifies hours of the global minimum staffing input parameter that are left unused by any participating activity during that time period (i.e. after removing workload of all activities that participate of both types: normal activities and no-increment activities). So, when the array in memory 1106 (of computer 300) shows a positive value for any element, then the method does not end in Step 3. Accordingly, Steps 4-7 (similar to Steps 1-2) are performed, now for using mobile workload activities that are identified as participating, by including normal activities and no-increment activities as described in detail below in reference to FIGS. 5C-5E to obtain an array 522 of unused global minimum staffing input parameter.

In Step 4, computer 300 creates one or more new time windows, based on values of array elements that are positive, as illustrated in FIG. 5C. Specifically, in FIG. 5C, as array 522 in memory 1106 has the value 2 from 10 AM to 12 PM, Time Window #1 is created in memory 1106, with the value 2, starting at 10 AM and ending at 12 PM. Similarly, Time Window #2 is created in memory 1106 with value 1 starting at 12 PM and ending at 1 PM. Also, Time Window #3 is created in memory 1106 with the value 2 starting at 1 PM and ending at 7 PM. In Step 5, computer 100 counts, within each time window, the number of activities that have mobile workloads in the time window, as illustrated in FIG. 5D. Next, in Step 6, computer 100 sorts the new time windows, in an ascending order of the number of mobile workload activities that occur therein. In the illustrated example, the output after Step 6 shown in FIG. 5D is coincidentally identical to the input before Step 6 also shown in FIG. 5D.

Next, in Step 7, computer 300 places mobile workloads into the respective time windows, as illustrated in memory 1106 of FIG. 5E followed by computing a difference between the array 522 and the mobile workloads, to obtain array 523 that identifies the portion of the Global Minimum Staffing input parameter which is unused after all participating activities are used (of both types: normal activities and no-increment activities).

Step 8: If global minimum staffing input parameter is reached in each time period (i.e. if all elements of array 523 are zero or negative), no workload adjustment is performed and the method ends. If global minimum staffing input parameter remains unused in any time period, then workloads of all participating activities are increased so that the increased workloads meet or exceed the global minimum staffing input parameter. Specifically, computer 300 simply adds up the global minimum staffing input parameter values that remain unused in each time period (add up all values in the array 523 to obtain a result 524 (e.g. value 4 as shown at the top of FIG. 5F) and then uses the result 524 to increment workloads of normal activities that participate in global minimum staffing but not workloads of no-increment activities.

Specifically, spreading of result 524 among workloads of participating normal activities but not among workloads of participating no-increment activities may be performed in two sub-steps as follows. Sub-step 8A: Calculate a factor to identify a percentage of the global workload to be used to increment the workload of each participating normal activity, to reach the global minimum staffing input parameter in each time period. Specifically, Factor=total global minimum staffing remaining in hours/total hours of normal activities participating in the global minimum staffing but not the no-increment activities. As illustrated in FIG. 5F, the total workload of all participating activities is 24 and the value of result 524 is 4, so the factor is 4/24 or 0.17. Sub-step 8B: Adjust workload of each participating normal activity but not any participating no-increment activity, by the factor as follows. Specifically, for each normal activity participating in global minimum staffing method (but not the no-increment activities), New workload=workload*(1+Factor). In the above-described example, most workloads are scaled up by 1.25, as shown in FIG. 2G.

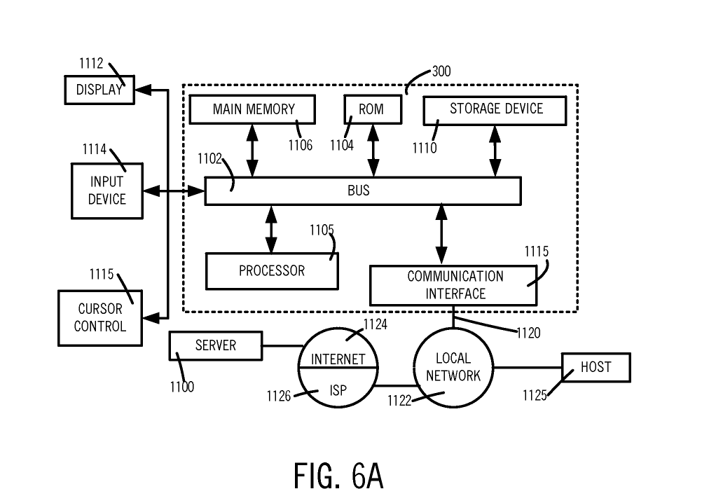

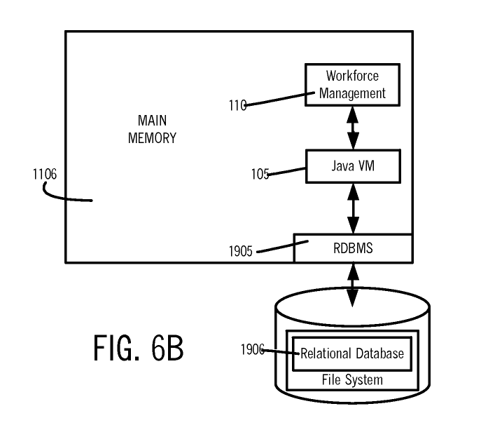

The method of FIG. 3 may be used to program one or more computer(s) 300, each of which may be implemented as illustrated in FIG. 6A which is discussed next. Specifically, computer 300 includes a bus 1102 (FIG. 6A) or other communication mechanism for communicating information, and one or more processor(s) 1105 coupled with bus 1102 for processing information. Computer 300 uses (as the above-described memory) a main memory 1106, such as a random access memory (RAM) or other dynamic storage device, coupled to bus 1102 for storing information and instructions (e.g. to perform the acts of FIG. 3) to be executed by processor 1105.

Main memory 1106 also may be used for storing temporary variables or other intermediate information during execution of instructions to be executed by processor 1105. Computer 300 further includes a read only memory (ROM) 1104 or other static storage device coupled to bus 1102 for storing static information and instructions for processor 1105, such as script processor 110. A storage device 1110, such as a magnetic disk or optical disk, is provided and coupled to bus 1102 for storing information and instructions.

Computer 300 may be coupled via bus 1102 to a display device or video monitor 1112 such as a cathode ray tube (CRT) or a liquid crystal display (LCD), for displaying information to a computer user (e.g. a store manager) may be displayed on display 1112. An input device 1114, including alphanumeric and other keys (e.g. of a keyboard), is coupled to bus 1102 for communicating information to processor 1105. Another type of user input device is cursor control 1116, such as a mouse, a trackball, or cursor direction keys for communicating information and command selections to processor 1105 and for controlling cursor movement on display 1112. This input device typically has two degrees of freedom in two axes, a first axis (e.g., x) and a second axis (e.g., y), that allows the device to specify positions in a plane.

As described elsewhere herein, workforce management is implemented by computer 300 in response to processor 1105 executing one or more sequences of one or more instructions that are contained in main memory 1106. Such instructions may be read into main memory 1106 from another non-transitory computer-readable storage medium, such as storage device 1110. Execution of the sequences of instructions contained in main memory 1106 causes processor 1105 to perform the operations of a process described herein and illustrated in FIG. 3. In alternative embodiments, hard-wired circuitry may be used in place of or in combination with software instructions to implement the invention. Thus, embodiments of the invention are not limited to any specific combination of hardware circuitry and software.

The term “non-transitory computer-readable storage medium” as used herein refers to any non-transitory storage medium that participates in providing instructions to processor 1105 for execution. Such a non-transitory storage medium may take many forms, including but not limited to (1) non-volatile storage media, and (2) volatile storage media. Common forms of non-volatile storage media include, for example, a floppy disk, a flexible disk, hard disk, optical disk, magnetic disk, magnetic tape, or any other magnetic medium, a CD-ROM, any other optical medium, punch cards, paper tape, any other physical medium with patterns of holes, a PROM, and EPROM, a FLASH-EPROM, any other memory chip or cartridge that can be used as storage device 1110. Volatile storage media includes dynamic memory, such as main memory 1106 which may be implemented in the form of a random access memory or RAM.

Instructions to processor 1105 can be provided by a transmission link or by a non-transitory storage medium from which a computer can read information, such as data and/or code. Specifically, various forms of transmission link and/or non-transitory storage medium may be involved in providing one or more sequences of one or more instructions to processor 1105 for execution. For example, the instructions may initially be comprised in a non-transitory storage device, such as a magnetic disk, of a remote computer. The remote computer can load the instructions into its dynamic memory (RAM) and send the instructions over a telephone line using a modem.

A modem local to computer 300 can receive information about a change to a collaboration object on the telephone line and use an infra-red transmitter to transmit the information in an infra-red signal. An infra-red detector can receive the information carried in the infra-red signal and appropriate circuitry can place the information on bus 1102. Bus 1102 carries the information to main memory 1106, from which processor 1105 retrieves and executes the instructions. The instructions received by main memory 1106 may optionally be stored on storage device 1110 either before or after execution by processor 1105.

Computer 300 also includes a communication interface 1115 coupled to bus 1102. Communication interface 1115 provides a two-way data communication coupling to a network link 1120 that is connected to a local network 1122. Local network 1122 may interconnect multiple computers (as described above). For example, communication interface 1115 may be an integrated services digital network (ISDN) card or a modem to provide a data communication connection to a corresponding type of telephone line. As another example, communication interface 1115 may be a local area network (LAN) card to provide a data communication connection to a compatible LAN. Wireless links may also be implemented. In any such implementation, communication interface 1115 sends and receives electrical, electromagnetic or optical signals that carry digital data streams representing various types of information.

Network link 1120 typically provides data communication through one or more networks to other data devices. For example, network link 1120 may provide a connection through local network 1122 to a host computer 1125 or to data equipment operated by an Internet Service Provider (ISP) 1126. ISP 1126 in turn provides data communication services through the world wide packet data communication network 1124 now commonly referred to as the “Internet”. Local network 1122 and network 1124 both use electrical, electromagnetic or optical signals that carry digital data streams. The signals through the various networks and the signals on network link 1120 and through communication interface 1115, which carry the digital data to and from computer 300, are exemplary forms of carrier waves transporting the information.

Computer 300 can send messages and receive data, including program code, through the network(s), network link 1120 and communication interface 1115. In the Internet example, a server 1100 might transmit information retrieved from RDBMS database through Internet 1124, ISP 1126, local network 1122 and communication interface 1115. The instructions for performing the operations of FIG. 3 may be executed by processor 1105 as they are received, and/or stored in storage device 1110, or other non-volatile storage for later execution. In this manner, computer 300 may additionally or alternatively obtain instructions and any related data in the form of a carrier wave.

Note that FIG. 6A is a very low-level representation of many hardware components of a computer system. Several embodiments have one or more additional software components in main memory 1106 as shown in FIG. 6B. Specifically, in such embodiments, computer 300 of FIG. 6A implements a relational database management system 1905 to manage data in one or more tables of a relational database 1906 of the type illustrated in FIG. 6B. Such a relational database management system 1905 may manage a distributed database system that includes multiple databases, each table being stored on different storage mechanisms.

In some embodiments, the multiple databases are made to appear as a single database. In such embodiments, processor 1105 can access and modify the data in a database 138 via RDBMS 1905 that accepts queries in conformance with a relational database language, the most common of which is the Structured Query Language (SQL). The commands are used by processor 1105 of some embodiments to store, modify and retrieve data about an application program in the form of rows in a table in relational database 1906. Relational database management system 1905 further includes output logic that makes the data in a database table available to a user via a graphical user interface that generates a display on a video monitor 1112. In one example, the output logic of computer 300 provides results via a web-based user interface that depicts in a browser, information 521 related to new workloads as illustrated in FIG. 5G which satisfy global minimum staffing. Additionally and/or alternatively, screens responsive to a command in a command-line interface and display on a video monitor may be generated in a graphical user interface of the type described above in reference to FIGS. 4A and 4B.

Numerous modifications and adaptations of the embodiments described herein will become apparent to the skilled artisan in view of this disclosure. Numerous modifications and adaptations of the embodiments described herein are encompassed by the scope of the invention.

What is claimed is:

1. A method performed in one or more computers, the method comprising:
receiving input on a first activity to be performed in a facility, the first activity having a first workload to be kept unchanged;
checking in each time period among a plurality of time periods during which the facility is open, whether a difference is greater than zero, between a minimum number of employees needed to open the facility and a current number of employees obtained based at least partially on a plurality of second workloads of second activities in the facility and the first workload of the first activity; and
when said checking finds that the difference is greater than zero in any time period among the plurality of time periods, at least one processor allocating an excess number of hours that are obtained based at least on said difference, to obtain and store in a computer memory changed second workloads while keeping at least the first workload of the first activity unchanged, such that a new current number of employees obtained based on at least the changed second workloads and the first workload, equals or exceeds in said each time period the minimum number of employees needed to open the facility.

2. The method of claim 1 wherein:
when the duration of the first activity is larger than a single time period in the plurality of time periods, the first workload is assigned to a sequence of time periods that occur successively one after another without break in the plurality of time periods.

3. The method of claim 1 wherein:
the second workloads of the second activities are determined based on labor standards; and
the first workload of the first activity is independent of the labor standards.

4. The method of claim 1 wherein:
the first workload is based on at least a user-specified number of repetitions received in said input and a user-specified duration of the first activity received in said input.

5. The method of claim 1 further comprising:
calculating the excess number of hours of minimum staffing, by at least summing up each difference between the minimum number and the current number, across the plurality of time periods.

6. The method of claim 1 wherein:
the first activity is identified by said input as participating in meeting global minimum staffing;
each of the second activities is identified by additional input as participating in meeting global minimum staffing; and
additional activities in said computer memory do not participate in meeting global minimum staffing.

7. One or more non-transitory computer-readable storage media comprising a plurality of instructions, the plurality of instructions comprising:
instructions to receive input comprising a number of repetitions of a first activity to be performed in a facility, and a duration of the first activity, wherein a first workload of the first activity is to be kept unchanged;
instructions to check in each time period among a plurality of time periods during which the facility is open, whether a difference is greater than zero, between a minimum number of employees needed to open the facility and a current number of employees obtained based at least partially on a plurality of second workloads of second activities in the facility and a first workload of the first activity, wherein the first workload is based on at least the number of repetitions and the duration of the first activity; and
instructions to allocate an excess number of hours to meet the minimum number that are obtained based at least on said difference, to obtain and store in a computer memory new second workloads while keeping at least the first workload of the first activity unchanged such that a new current number obtained based on at least the new second workloads and the first workload, equals or exceeds the minimum number in each time period;
wherein the instructions to allocate are to be executed after execution of said instructions to check finds that the difference is greater than zero in any time period among the plurality of time periods.

8. The one or more computer-readable storage media of claim 6 wherein:
on execution of said plurality of instructions, when the duration of the first activity is larger than a single time period in the plurality of time periods, the first workload is assigned to a sequence of time periods that occur successively one after another without break in the plurality of time periods.

9. The one or more computer-readable storage media of claim 6 wherein on execution of said plurality of instructions:
the second workloads of the second activities are determined based on labor standards; and
the first workload of the first activity is independent of the labor standards.

10. The one or more computer-readable storage media of claim 6 further comprising:
instructions to calculate the excess number of hours of minimum staffing, by at least summing up each difference between the minimum number and the current number, across the plurality of time periods.

11. The one or more computer-readable storage media of claim 6 wherein:
the first activity is identified by said input as being used by the instructions to check;
each of the second activities is identified by additional input as being used by the instructions to check; and
additional activities in said computer memory are not used by the instructions to check.

12. An apparatus comprising at least one processor coupled to a memory, the apparatus comprising:
means for receiving input comprising a number of repetitions of a first activity, and a duration of the first activity;
means for checking in each time period among a plurality of time periods during which a facility is open, whether a difference is greater than zero, between a minimum number of employees needed to open the facility and a current number of employees obtained based at least partially on a plurality of second workloads of second activities in the facility and a first workload of the first activity, wherein the first workload is based on at least the number of repetitions and the duration of the first activity; and
means for allocating an excess number of hours of minimum staffing that are obtained based at least on said difference, among the second workloads of the second activities, to obtain and store in said memory new second workloads while keeping the first workload of the first activity unchanged such that a new current number based on at least the new second workloads and the first workload, equals or exceeds the minimum number in each time period;
wherein the means for allocating is responsive to the means for checking finding that the difference is greater than zero in any time period among the plurality of time periods.

13. The apparatus of claim 11 wherein:
when the duration of the first activity is larger than a time period in the plurality of time periods, the first workload is assigned to a sequence of time periods that occur successively one after another without break in the plurality of time periods.

14. The apparatus of claim 11 wherein:
the second workloads of the second activities are determined based on labor standards; and
the first workload of the first activity is independent of the labor standards.

15. The apparatus of claim 11 further comprising:
means for calculating the excess number of hours of minimum staffing, by at least summing up each difference between the minimum number and the current number, across the plurality of time periods.

16. The apparatus of claim 11 wherein:
the first activity is identified by said input as participating in meeting global minimum staffing;
each of the second activities is identified by additional input as participating in meeting global minimum staffing; and
additional activities in said computer memory do not participate in meeting global minimum staffing.
